(19) United States
(12) Patent Application Publication
(10) Pub. No.: US 2023/0243953 A1
(43) Pub. Date: Aug. 3, 2023

(54) INFORMATION PROCESSING APPARATUS AND INFORMATION PROCESSING METHOD

(71) Applicant: SONY GROUP CORPORATION, TOKYO (JP)

(72) Inventor: KAZUFUMI FUJIYA, KANAGAWA (JP)

(21) Appl. No.: 18/000,805

(22) PCT Filed: Jun. 1, 2021
(86) PCT No.: PCT/JP2021/020798

§ 371 Date: Dec. 5, 2022

(30) Foreign Application Priority Data
Jun. 12, 2020 (JP) 2020-102079

(51) Int. Cl. G01S 13/72; G01S 13/86

(52) U.S. Cl. CPC G01S 13/723; G01S 13/867

(57) ABSTRACT

An information processing apparatus (1) according to an embodiment includes: a detection unit (100a to 100d, 200a to 200c) that detects a target based on an observation value acquired from an output of a sensor, a generation unit (301) that generates observation identification information, in which the target detected by the detection unit based on the observation value is associated with the sensor relating to the observation value, and a control unit (300) that controls holding, in a holding unit, of the observation identification information generated by the generation unit. The generation unit generates the observation identification information for each of one or more targets detected by the detection unit.

### FIELD

The present disclosure relates to an information processing apparatus and an information processing method. Background

There is known a tracking technique of detecting a target using a sensor such as a camera or a radar and tracking the target detected. There is also known a technique of tracking the target using a plurality of sensors. For example, by using the plurality of sensors having different characteristics, tracking can be executed with higher accuracy.

### CITATION LIST

### Patent Literature

Patent Literature 1: JP 2018-66716 A

### SUMMARY

### Technical Problem

When tracking is performed using a plurality of sensors, it is important to associate a target with an observation value of each sensor. There are cases where a plurality of targets is detected by each of the plurality of sensors, and as the number of observation values in each sensor increases, time required for selecting a target to be associated with each observation value increases.

It is therefore an object of the present disclosure to provide an information processing apparatus and an information processing method capable of executing tracking using a plurality of sensors in a further short time.

### Solution to Problem

For solving the problem described above, a information processing apparatus according to one aspect of the present disclosure has a detection unit that detects a target based on an observation value acquired from an output of a sensor; a generation unit that generates observation identification information in which the target detected by the detection unit based on the observation value is associated with the sensor relating to the observation value, the observation identification information being generated for each of one or a plurality of the targets detected by the detection unit; and a control unit that controls holding, in a holding unit, of the observation identification information generated by the generation unit.

### BRIEF DESCRIPTION OF DRAWINGS

FIG. 1 is a schematic diagram illustrating an outline of a tracking system according to an embodiment.

FIG. 2 is a schematic diagram illustrating a tracking process according to the embodiment.

FIG. 3 is a functional block diagram of an example illustrating functions of a tracking system 1 according to the embodiment.

FIG. 4 is a schematic diagram illustrating a gating process applicable to the embodiment.

FIG. 5 is a block diagram illustrating a hardware configuration example of an information processing apparatus capable of realizing the tracking system according to the embodiment.

FIG. 6 is a flowchart illustrating an example of processing in the tracking system 1 according to the embodiment.

FIG. 7 is a schematic diagram further specifically illustrating the tracking process according to the embodiment.

FIG. 8 is a schematic diagram illustrating still another example of the tracking process according to the embodiment.

FIG. 9A is a schematic diagram illustrating an example of an image captured by a camera.

FIG. 9B is a bird’s-eye view schematically illustrating an example of a detection result of each object group when tracking is executed.

### DESCRIPTION OF EMBODIMENTS

Hereinafter, embodiments of the present disclosure will be described in detail with reference to the drawings. Note that, in the following embodiments, same parts are denoted by same reference signs to omit redundant description.

Hereinafter, the embodiments of the present disclosure will be described in the following order.
1. Outline of present disclosure
2. Embodiment
2-1. Outline of embodiment
2-2. Configuration applicable to embodiment
2-2-1. Functional configuration example
2-2-2. Hardware configuration example
2-3. Processing according to embodiment
2-3-1. Specific example of processing according to embodiment
2-4. Comparison with existing technology

### 1. Outline of Present Disclosure

A tracking system according to the present disclosure employs a plurality of sensors to track a target based on a sensor output from each of the plurality of sensors, and integrate tracking results of the plurality of sensors. In the tracking system according to the present disclosure, identification information is generated and held for each sensor used for tracking a tracking target separately from a tracking ID to identify the tracking. More specifically, in the tracking system according to the present disclosure, the identification information for identifying a sensor used for tracking and identification information for identifying the tracking are associated and held as an observation ID of each sensor.

In the present disclosure, when an observation value is associated with the tracking target, it is possible to reduce a calculation amount, absorb a tracking error in a preceding step, shorten a tracking process time, and improve final tracking accuracy by referring to an observation ID in the preceding step and an observation ID held in a subsequent step.

### 2. Embodiment

Next, an embodiment of the present disclosure will be described.

### 2-1. Outline of Embodiment

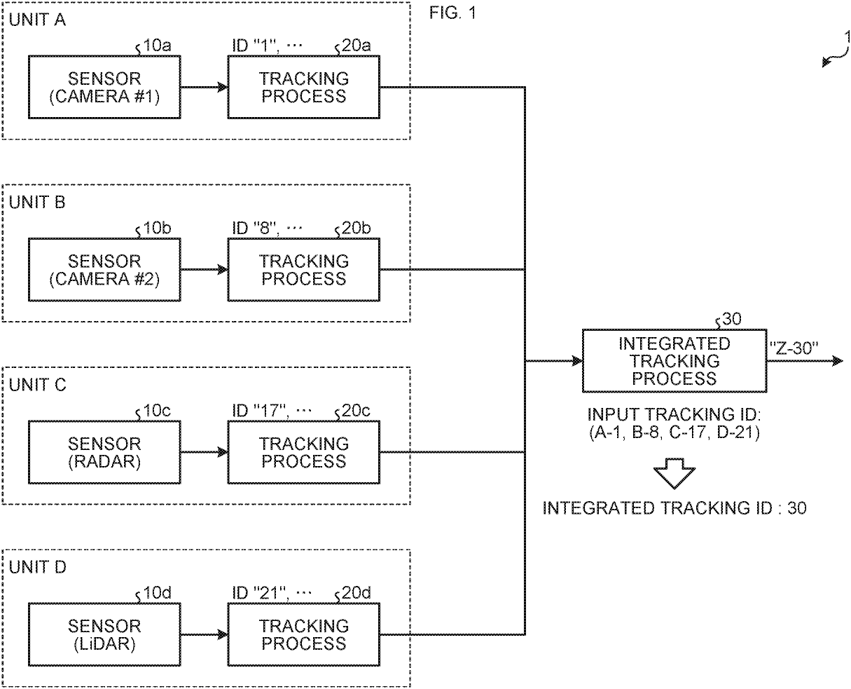

First, an outline of the embodiment of the present disclosure will be described. FIG. 1 is a schematic diagram illustrating the outline of a tracking system according to the embodiment. In an example in FIG. 1, a tracking system 1 detects a tracking target using four sensors 10a to 10d. In this example, the sensors 10a and 10b are cameras, the sensor 10c is a radar, and the sensor 10d is a light detection and ranging or laser imaging detection and ranging (LiDAR).

The cameras (camera #1 and camera #2 in FIG. 1) as the sensors 10a and 10b detect light having a wavelength in a visible light region and output a detection result as a captured image. Alternatively, the cameras #1 and #2 may detect light having a wavelength in an infrared region and light having a wavelength in an ultraviolet region.

The radar as the sensor 10c emits, for example, a millimeter wave and detects its reflected wave. A detection result of the radar is output as a point group corresponding to an emission position of the millimeter wave. The LiDAR as the sensor 10d emits an electromagnetic wave such as laser light having a wavelength shorter than that of the radar and detects its reflected light. Similarly to the radar, a detection result of LiDAR is output as a point group corresponding to an emission position of the laser light.

Note that FIG. 1 illustrates the example in which the four sensors 10a to 10d are used in the tracking system 1, but this is not limited to the example. In other words, in the tracking system 1 applicable to the embodiment, two or three, or five or more sensors may be used as long as a plurality of sensors is used for detecting the tracking target.

In addition, a combination of the plurality of sensors can be handled as one sensor. For example, a combination of two or more cameras can be handled as one sensor. Furthermore, for example, different types of sensors such as the camera and the laser or the camera and the LiDAR may be combined and handled as one sensor. Handling of a combination of the plurality of sensors as one sensor in this way is referred to as fusion. In addition, one sensor obtained by combining the plurality of sensors may be referred to as a fusion sensor.

The tracking system 1 executes a tracking process 20a using the observation value based on the output of the sensor 10a, detects an object, and tracks the object detected. Note that, in the tracking process 20a, it is possible to detect a plurality of objects based on the output of the sensor 10a. The tracking system 1 associates the identification information (referred to as a tracking ID) with each object detected in the tracking process 20a. In the example of the drawing, a tracking ID “1” and so on are associated with objects detected in the tracking process 20a.

The sensors 10b, 10c, and 10d are similar to the sensor 10a. In other words, the tracking system 1 executes tracking processes 20b, 20c, and 20d based on outputs of the sensors 10b, 10c, and 10d, respectively, detects an object, and tracks the object detected. The tracking system 1 associates a tracking ID with each object detected in each of the tracking processes 20b, 20c, and 20d. In the example in FIG. 1, a tracking ID “8” and so on, a tracking ID “17” and so on, and a tracking ID “21” and so on are associated with the objects detected in the tracking processes 20b, 20c, and 20d, respectively.

Here, in the tracking processes 20a, 20b, 20c, and 20d, an object is generated using the observation value based on the output of each of the sensors 10a, 10b, 10c, and 10d to detect the object. As the observation value, image information can be applied when the sensor is the camera. In addition, when the sensor is the radar or the LiDAR, point group information can be applied as the observation value. Still more, the observation value can include position information indicating a position of the object. The present invention is not limited thereto, and the position information may also be obtained based on the observation value.

Hereinafter, a set of the sensor and the tracking process based on the output of the sensor is referred to as a unit. In the example in FIG. 1, a set of the sensor 10a and the tracking process 20a is a unit A, a set of the sensor 10b and the tracking process 20b is a unit B, a set of the sensor 10c and the tracking process 20c is a unit C, and a set of the sensor 10d and the tracking process 20d is a unit D.

In an integrated tracking process 30, the tracking system 1 associates the tracking ID acquired in each of the units A to D with identification information for identifying the unit that has acquired the tracking ID, and generates an observation ID. In the example in FIG. 1, the tracking system 1 sets the identification information for identifying the units A to D as “A”, “B”, “C”, and “D”, respectively, and associates the tracking IDs detected in the respective units with these “A”, “B”, “C”, and “D” in the integrated tracking process 30.

Each of the units A to D has a one-to-one correspondence with one of the sensors 10a to 10d (including a fusion sensor). Therefore, the identification information “A” to “D” for identifying each of the units A to D is identification information for identifying each of the sensors 10a to 10d.

As an example, the tracking ID “1” associated with the object detected by the tracking process 20a in the unit A is transmitted to the integrated tracking process 30. In the integrated tracking process 30, the tracking ID “1” received from the unit A is associated with the identification information “A” for identifying the unit A to generate an observation ID “A-1”. The observation ID “A-1” is the identification information corresponding to the observation value used for detecting the object indicated by the tracking ID “1” corresponding to the tracking target.

The same applies to the units B, C, and D. In other words, in the unit B, for example, the tracking ID “8” corresponding to the tracking target is transmitted to the integrated tracking process 30. In the integrated tracking process 30, the tracking ID “8” is associated with the identification information “B” for identifying the unit B to generate the observation ID “B-8”. Similarly in the units C and D, the integrated tracking process 30 associates the tracking IDs “17” and “21” corresponding to the respective tracking targets, received from the unit C and unit D, respectively, with the identification information “C” and “D” for identifying the units C and D to generate the observation IDs “C-17” and “D-21”.

The tracking system 1 integrates, in the integrated tracking process 30, observation IDs associated with tracking IDs with which the same object is assumed to be tracked among the observation IDs generated in the units A to D. In the example in FIG. 1, in the units A, B, C, and D, it is estimated that the objects tracked with the tracking IDs “1”, “8”, “17”, and “21” are the same object. Therefore, in the integrated tracking process 30, the observation IDs “A-1”,“B-8”, “C-17”, and “D-21” corresponding to the tracking IDs “1”, “8”, “17”, and “21” of the units A, B, C, and D are integrated.

In the integrated tracking process 30, the tracking system 1 associates an integrated tracking ID (“30” in the example in FIG. 1) with the integrated observation IDs “A-1”, “B-8”, “C-17”, and “D-21”. In the integrated tracking process 30, the tracking system 1 associates identification information (“Z” in the example in FIG. 1) indicating integration of a plurality of observation IDs with an integrated tracking ID “30”, and outputs a new tracking ID “Z-30”.

From this integrated observation ID “Z-30”, it is possible to refer to each of the observation IDs “A-1”, “B-8”,“C-17”, and “D-21” integrated into the observation ID “Z-30”. Furthermore, it is possible to refer to the tracking IDs “1”, “8”, “17”, and “21” from the observation IDs “A-1”,“B-8”, “C-17”, and “D-21”, and acquire a position and an observation value of the object associated with each of the tracking IDs “1”,“8”, “17”, and “21”.

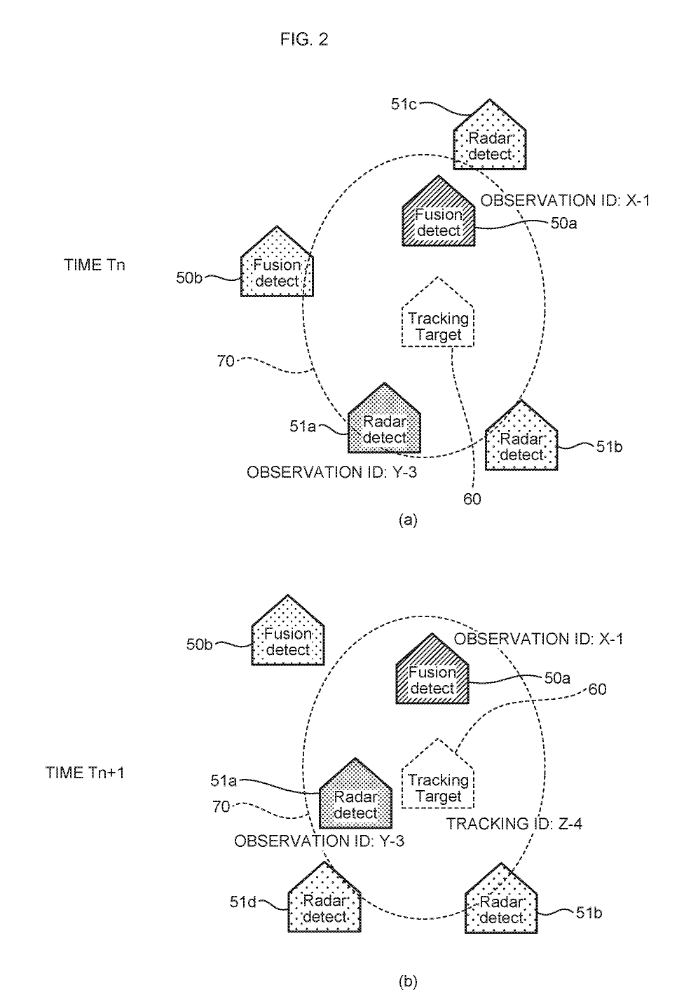

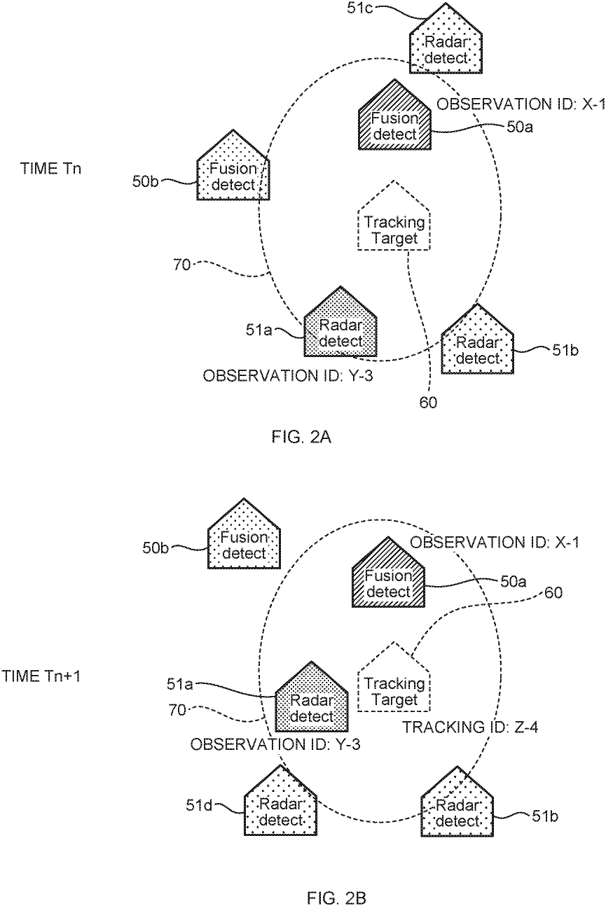

FIG. 2 is a schematic diagram illustrating the tracking process according to the embodiment. In a bird’s-eye view, section (a) of FIG. 2 illustrates an example of a detection result at time Tn, and section (b) illustrates an example of a detection result at time Tn + 1 after a predetermined time has elapsed from the state of section (a). Note that, here, the radar and the fusion sensor that is a combination of a plurality of arbitrary sensors are used as sensors, and the fusion sensor and its tracking process are referred to as a unit X, and the radar and its tracking process are referred to as a unit Y.

In section (a) of FIG. 2, objects 50a and 50b are detected by the fusion sensor (unit X). In addition, objects 51a, 51b, and 51c are detected by the radar (unit Y). On the other hand, an object 60 as a tracking target (hereinafter referred to as a tracking target 60) is generated based on a detection result obtained temporally prior to (before) time Tn. Based on a position of this tracking target 60, a gating region 70 for determining whether or not the tracking target 60 is detected is set by, for example, a known gating process to be described later. In other words, objects detected inside the gating region 70 is determined as the objects detecting the tracking target 60 as a tracking target.

In an example of section (a) of FIG. 2, the objects 50a and 51a are inside the gating region 70, and the tracking system 1 determines that the objects 50a and 51b are detecting the tracking target 60. These objects 50a and 51a are generated according to observation values based on outputs of respective sensors. Therefore, the tracking system 1 holds the observation ID of each observation value used to generate the objects 50a and 51a in association with the objects 50a and 51a.

In other words, the object 50a is an object with the tracking ID “1” among the objects detected in the unit X with the identification information “X”. Therefore, for the object 50a, the tracking system 1 holds an observation ID “X-1” corresponding to the observation value used for detection in association with the unit X and the tracking ID “1”.

The same applies to the object 51a. In this example, the object 51a is an object with a tracking ID “3” among the objects detected in the unit Y. Therefore, the tracking system 1 holds an observation ID “Y-3” corresponding to the observation value used for detection of the object 51a in association with the unit Y and the tracking ID “3”.

Note that, in section (a) of FIG. 2, with respect to the tracking target 60, the tracking system 1 ignores the objects 50b, 51b, and 51c outside the gating region 70.

The tracking ID “1” corresponding to the object 50a is a local tracking ID in the unit X. Similarly, the tracking ID “3” corresponding to the object 51a is a local tracking ID in the unit Y.

As illustrated in section (b) of FIG. 2, at the time Tn + 1 after a lapse of a predetermined time from the time Tn in section (a), the objects 50a and 50b detected by the unit X and the objects 51a and 51b detected by the unit Y at the time Tn are detected again, and furthermore, the objects 50b, 51a, and 51b are moved from positions at the time Tn. In addition, an object 51d is newly detected by the unit Y, and the object 51c detected at the time Tn is not detected.

Here, at the time Tn + 1, the position of the object 51a has moved from the state at the time Tn. On the other hand, in the unit Y, even after positional movement, the object 51a is an object inside the gating region 70 and detected as the same object as the object 51a detected at the time Tn before the positional movement. Therefore, at the time Tn + 1, the tracking system 1 generates the observation ID “Y-3” using the tracking ID “3” of the object 51a detected at the time Tn. Here, the tracking system 1 updates the observation value of the object 51a corresponding to the observation ID “Y-3” acquired at the time Tn with an observation value acquired at the time Tn + 1.

In addition, the tracking system 1 integrates the observation IDs “X-1” and “Y-3” of the objects 50a and 51a detected inside the gating region 70 in the integrated tracking process 30 to generate a tracking ID “Z-4”. The tracking ID “Z-4” is associated with the observation IDs “X-1” and “Y-3”.

In other words, a result of performing tracking using the observation values with the observation IDs “X-1” and “Y-3” at the time Tn + 1 is indicated as the tracking ID “Z-4”. Therefore, the tracking ID indicating the tracking target 60 as the tracking target is the tracking ID “Z-4”, and the observation IDs “X-1” and “Y-3” are associated with the tracking ID “Z-4”.

Furthermore, at the time Tn, the state of the tracking target 60 as the tracking target indicated by the tracking ID “Z-4” is updated in association with the observation IDs “X-1” and “Y-3”. When there is an observation ID corresponding to the time Tn at the time Tn + 1 (in this example, the observation IDs “X-1” and “Y-3”), it is possible to reduce a load such as an object detection process by using these corresponding observation IDs.

### 2-2. Configuration According to Embodiment

Next, a configuration according to the embodiment will be described.

### 21. Functional Configuration Example

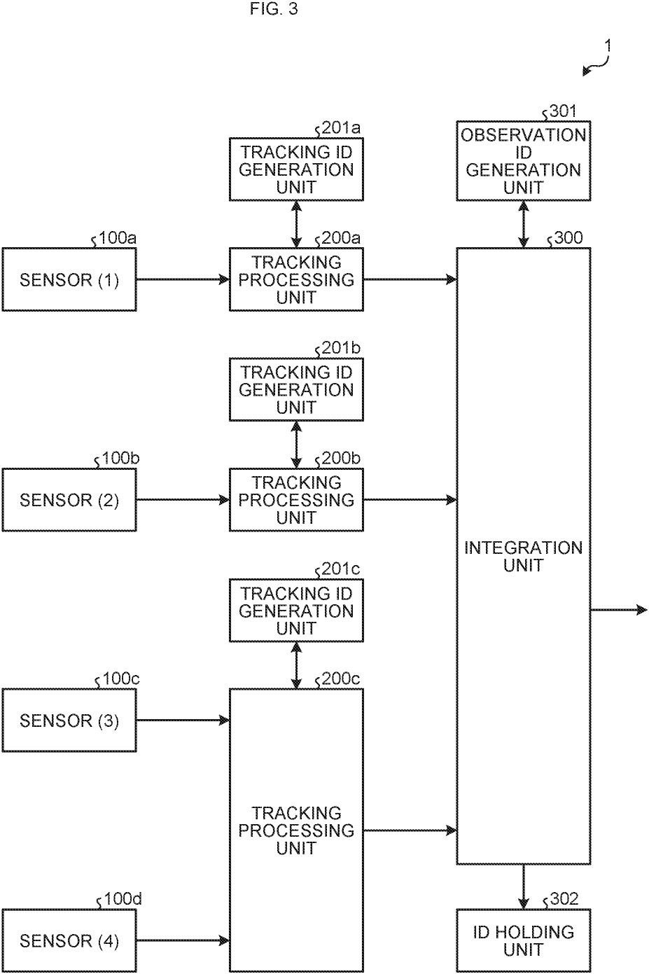

First, an example of a functional configuration according to the embodiment will be described. FIG. 3 is a functional block diagram of the example illustrating functions of the tracking system 1 according to the embodiment. In FIG. 3, the tracking system 1 includes sensors 100a, 100b, 100c, and 100d, tracking processing units 200a, 200b, and 200c, tracking ID generation units 201a, 201b, and 201c, an integration unit 300, an observation ID generation unit 301, and an ID holding unit 302.

Among these, the tracking processing units 200a, 200b, and 200c, the tracking ID generation units 201a, 201b, and 201c, the integration unit 300, an observation ID generation unit 301, and an ID holding unit 302 are realized by executing an information processing program according to the embodiment on a CPU to be described later. Not limited thereto, some or all of the tracking processing units 200a, 200b, and 200c, the tracking ID generation units 201a, 201b, and 201c, the integration unit 300, the observation ID generation unit 301, and the ID holding unit 302 can be configured by hardware circuits that operate in cooperation with each other.

Note that, in an example in FIG. 3, the sensors 100c and 100d in the sensors 100a to 100d are configured as the fusion sensor that uses outputs in combination. Furthermore, the sensors 100a to 100d are also illustrated as a sensor (1), a sensor (2), a sensor (3), and a sensor (4), respectively, in FIG. 3. Here, each of the sensors 100a to 100d is assumed to be any of the camera, the radar, and the LiDAR.

The tracking processing unit 200a extracts the observation value indicating an object from the output of the sensor 100a, and detects the object based on the observation value extracted. Furthermore, the tracking processing unit 200a performs tracking of the object by, for example, comparing the newly detected object with the object detected temporally before the object.

For example, when the sensor 100a is the camera and the output of the sensor 100a is image data, the tracking processing unit 200a analyzes the image data supplied from the sensor 100a to extract a feature amount, and executes a recognition process using the feature amount extracted to detect the object.

Furthermore, for example, when the sensor 100a is the radar or the LiDAR, it is possible to obtain the point group information that is a set of points each having information on a distance and a direction based on the output of the sensor 100a. The tracking processing unit 200a generates the point group information based on the data supplied from the sensor 100a, and performs clustering on the point group information generated according to a predetermined condition. As a condition for clustering, for example, it is conceivable to apply a set of points at which the distance between the points is within a predetermined distance, a set of points at the same moving speed, or the like. The tracking processing unit 200a detects objects in each clustering unit.

In this way, the tracking processing unit 200a functions as a detection unit that detects a target (object) based on the observation value acquired from the output of the sensor 100a.

The tracking ID generation unit 201a generates the tracking ID with respect to the object detected by the tracking processing unit 200a for identifying the object. Tracking ID generation unit 201a transmits the tracking ID generated to the tracking processing unit 200a.

The tracking processing unit 200a performs tracking on the object detected by using the tracking ID received from the tracking ID generation unit 201a. The tracking processing unit 200a transmits the tracking ID of the object tracked to the integration unit 300.

Processes in the tracking processing unit 200b and tracking ID generation unit 201b are similar to the processes in the tracking processing unit 200a and the tracking ID generation unit 201a described above. Thus, the description thereof is omitted here.

The tracking processing unit 200c extracts an observation value indicating an object from the output of each of the sensors 100c and 100d, and detects the object based on the observation value extracted. For example, the tracking processing unit 200c can take a logical product of the object based on the output of the sensor 100c and the object based on the output of the sensor 100d, and use the logical product as the object based on the output of the fusion sensor of the sensors 100c and 100d.

The tracking ID generation unit 201c generates a tracking ID for identifying the object detected by the tracking processing unit 200c based on outputs from sensors 100c and 100d. The tracking ID generation unit 201c transmits the tracking ID generated to the tracking processing unit 200c.

Similarly to the tracking processing unit 200a described above, the tracking processing unit 200c performs tracking of the object detected using the tracking ID received from the tracking ID generation unit 201c. The tracking processing unit 200c transmits the tracking ID of the object tracked to the integration unit 300.

Note that a set of the sensor 100a, the tracking processing unit 200a, and the tracking ID generation unit 201a, a set of the sensor 100b, the tracking processing unit 200b, and the tracking ID generation unit 201b, and a set of the sensor 100c, the sensor 100d, the tracking processing unit 200c, and the tracking ID generation unit 201a correspond to the respective units.

The integration unit 300 receives the tracking ID from each of the tracking processing units 200a, 200b, and 200c. The observation ID generation unit 301 generates each observation ID by associating the identification information that identifies an output source unit of each tracking ID with each tracking ID received by the integration unit 300. The observation ID generation unit 301 transmits the observation IDs generated to the integration unit 300.

As described above, the observation ID generation unit 301 functions as a generation unit that generates observation identification information (observation ID) in which the target detected by the detection unit (tracking processing unit 200a) based on the observation value is associated with the sensor relating to the observation value.

The integration unit 300 extracts the observation ID corresponding to the same object from the observation IDs received from the observation ID generation unit 301, and associates the identification information (integrated tracking ID) generated by the observation ID generation unit 301 with each observation ID extracted.

More specifically, the observation ID generation unit 301 generates one integrated tracking ID with respect to observation IDs corresponding to the same object extracted by the integration unit 300, and transmits the integrated tracking ID generated to the integration unit 300. The integration unit 300 associates the integrated tracking ID received from the observation ID generation unit 301 with each corresponding observation ID, and holds the integrated tracking ID in the ID holding unit 302. Furthermore, the integration unit 300 holds each observation value corresponding to the integrated tracking ID in, for example, the ID holding unit 302 in association with the integrated tracking ID.

As described above, the integration unit 300 functions as a control unit that controls the holding of the observation identification information (observation ID) generated by the generation unit (observation ID generation unit 301) in the holding unit (ID holding unit 302).

Here, when different observation values occur with the same object, the integration unit 300 updates the observation value corresponding to the object held in the ID holding unit 302. Furthermore, when an observation ID different from the observation ID associated with the integrated tracking ID held in the ID holding unit 302 is generated for the same object, the integration unit 300 updates the integrated tracking ID using that observation ID.

The integration unit 300 can apply a known method called gating or validation region (hereinafter referred to as gating) to a process of selecting an object corresponding to a tracking target from a plurality of objects.

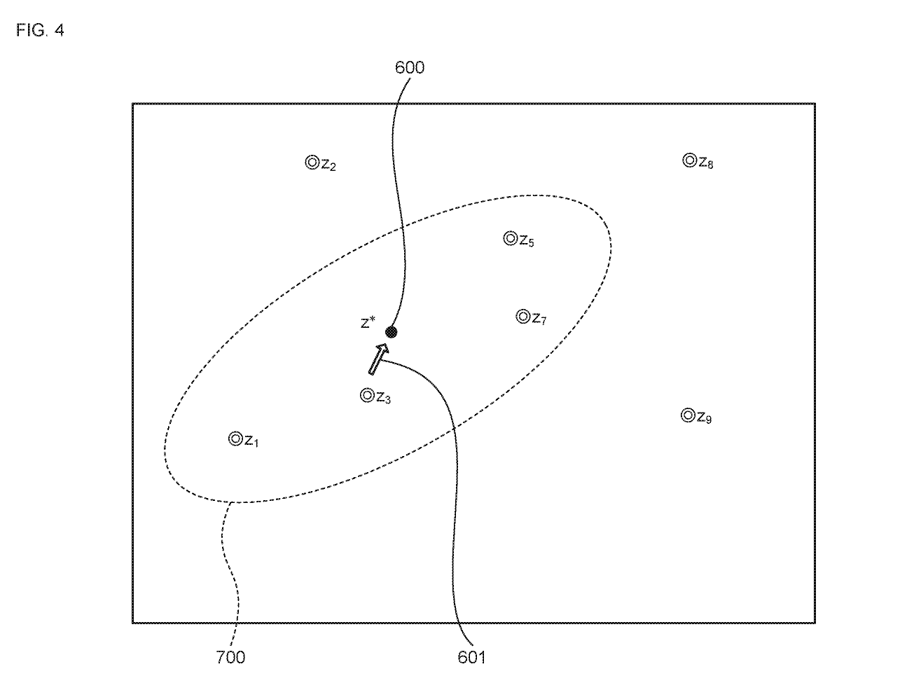

FIG. 4 is a schematic diagram illustrating a gating process applicable to the embodiment. In FIG. 4, it is assumed that observation values (objects) z₁, z₂, z₃ to z₉ are obtained. Furthermore, it is assumed that the position of a tracking target 600 is estimated by a prior process.

The gating process is a filtering process of setting an arbitrary noise variance value and selecting up to which range (gating range 700) of observation values among the observation values z₁, z₂, and z₃ to z₉ are set as observation value candidates corresponding to the tracking target 600 in a probability distribution. For example, a difference between the tracking target 600 and the observation value is obtained for each of target observation values among the observation values z₁, z₂, z₃, to z₉, and each element to be described later is divided by the variance of differences obtained. It is determined whether or not the total value (Mahalanobis distance) is within the gating range 700.

In an example in FIG. 4, the observation values z₁, z₃, z₅, and z₇ among the observation values z₁, z₂, and z₃ to z₉ are inside the gating range 700 (corresponding to the gating region 70 in FIG. 2) and are candidates to be associated with the tracking target. Furthermore, the observation value z₃ in the observation values z₁, z₃, z₅, and z₇ is the closest to the tracking target 600. Therefore, as indicated by an arrow 601 in the drawing, the observation value z₃ is associated with the tracking target 600.

For example, a position (x, y, z) of the observation value (object), a speed of the observation value, and a vertical width, the horizontal width, and a depth of the observation value can be applied to the above-described element.

In this manner, processing can be reduced by reducing the number of candidate objects by the gating process to narrow a search range.

### 22. Hardware Configuration Example

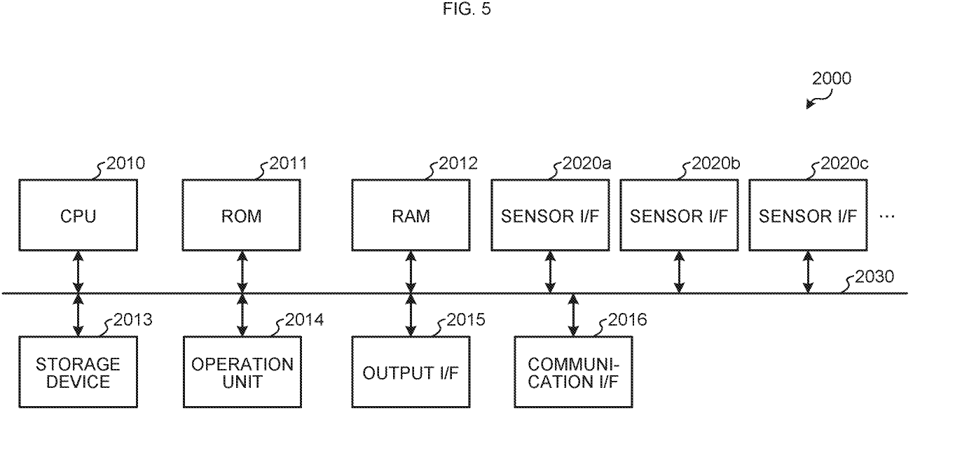

Next, an information processing apparatus capable of realizing the tracking system 1 according to the embodiment will be described. FIG. 5 is a block diagram illustrating a hardware configuration of an example of the information processing apparatus capable of realizing the tracking system 1 according to the embodiment.

In FIG. 5, an information processing apparatus 2000 includes a central processing unit (CPU) 2010, a read only memory (ROM) 2011, a random access memory (RAM) 2012, a storage device 2013, an operation unit 2014, an output I/F 2015, and a communication I/F 2016 that are communicably connected to each other by a bus 2030. The information processing apparatus 2000 further includes sensor I/Fs 2020a, 2020b, 2020c, and so on connected to the bus 2030.

The storage device 2013 is a nonvolatile storage medium such as a flash memory or a hard disk drive. The storage device 2013 can store an information processing program for operating the CPU 2010 and can store various pieces of data used by the information processing program.

The CPU 2010 operates using the RAM 2012 as a work memory according to the information processing program stored in the ROM 2011 and the storage device 2013, and controls the entire operation of the information processing apparatus 2000.

The operation unit 2014 includes an operator for receiving a user operation. The operation unit 2014 transmits a control signal corresponding to the user operation on the operator to the CPU 2010. Furthermore, the operation unit 2014 may further include a display element or the like for presenting information to the user.

The output I/F 2015 is an interface for connecting the information processing apparatus 2000 and an external device, and data generated by the information processing apparatus 2000 is transmitted to the external device via the output I/F 2015. The communication I/F 2016 is an interface for communicating with the outside of the information processing apparatus 2000 by wireless or wired communication. The information processing apparatus 2000 can communicate with an external network such as the Internet or a local area network (LAN) via the communication I/F 2016.

The sensor I/Fs 2020a, 2020b, 2020c, and so on are interfaces with the respective sensors 100a, 100b, and so on such as the camera, the radar, and the LiDAR. The CPU 2010 can control the sensors 100a, 100b, and so on via the sensor I/Fs 2020a, 2020b, 2020c, and so on, and can also acquire outputs of the sensors 100a, 100b, and so on.

Note that, for example, each of the sensor I/Fs 2020a, 2020b, 2020c, and so on can store the identification information for identifying its own hardware in advance. The CPU 2010 can be notified based on the identification information that data supplied from the sensor I/Fs 2020a, 2020b, 2020c,.and so on is acquired from which of the sensor I/Fs 2020a, 2020b, 2020c, and so on, i.e., from which of the sensors connected to the sensor I/Fs 2020a, 2020b, 2020c, and so on. The present invention is not limited thereto, and the CPU 2010 may also directly acquire the identification information for identifying each sensor from each sensor connected to the sensor I/Fs 2020a, 2020b, 2020c, and so on.

For example, the CPU 2010 executes the information processing program according to the embodiment to configure a module of each of the tracking processing units 200a, 200b, and 200c, the tracking ID generation units 201a, 201b, and 201c, the integration unit 300, the observation ID generation unit 301, and the ID holding unit 302 described above on a main storage area of the RAM 2012. The information processing program can be acquired from the outside (e.g., server device) by communication via the communication I/F 2016, for example, and can be installed on the information processing apparatus 2000.

### 2-3. Processing According to Embodiment

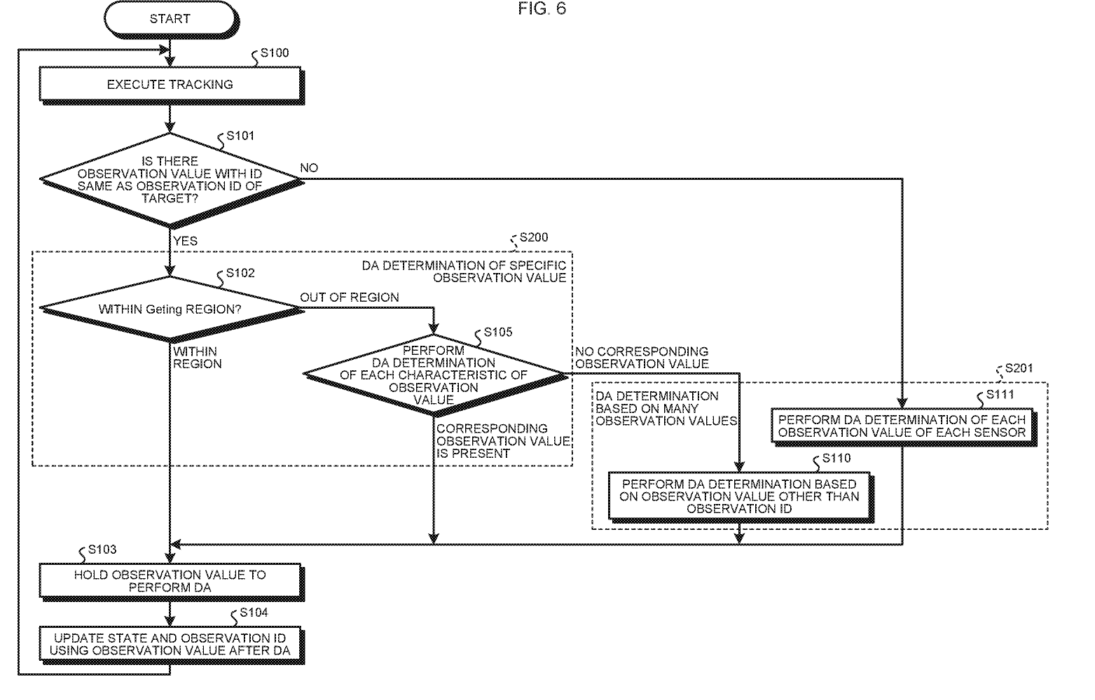

Next, processing in the tracking system 1 according to the embodiment will be described more specifically. FIG. 6 is a flowchart illustrating an example of processing in the tracking system 1 according to the embodiment. Note that, here, the tracking system 1 described with reference to FIG. 3 will be described as an example. In addition, it is assumed that the tracking system 1 has already generated the integrated tracking ID corresponding to the tracking target 60 based on outputs of the sensors 100a, 100b, and so on, and the integration unit 300 holds the integrated tracking ID generated in the ID holding unit 302. At the same time, it is assumed that the gating region 70 is already set based on the position of the tracking target 60.

In FIG. 6, in Step S100, the tracking system 1 executes the tracking process by each of the tracking processing units 200a, 200b, and so on based on outputs of the sensors 100a, 100b, and so on.

In next Step S101, the tracking system 1 causes the integration unit 300 to compare the observation ID associated with the integrated tracking ID corresponding to the tracking target 60 with observation IDs acquired by the tracking process in Step S100. Then, the integration unit 300 determines whether or not the observation IDs acquired include the same observation ID as the observation ID associated with the integrated tracking ID. When the integration unit 300 determines that there is the same observation ID (Step S101, “Yes”), the process proceeds to Step S102.

Note that, when a plurality of observation IDs (observation values) is acquired in Step S100, the process in Step S101 and after Step S101 is executed for each of the plurality of observation IDs acquired.

In Step S102, the integration unit 300 determines whether or not the acquired observation ID is inside the gating region 70. When it is determined in Step S102 that the acquired observation ID is inside the gating region 70 (Step S102, “within region”), the integration unit 300 determines that the observation ID is the observation ID corresponding to the observation ID included in the integrated tracking ID, and the process proceeds to Step S103.

Note that, when it is determined in Step S102 that the acquired observation ID is inside the gating region 70, the integration unit 300 does not use observation values acquired by a sensor other than the sensor from which the observation value corresponding to the observation ID has been acquired, and thus does not perform calculation on those observation values. As a result, a process load in the tracking system 1 is reduced.

In Step S103, the integration unit 300 associates the observation value with the observation ID corresponding to the observation ID included in the integrated tracking ID.

When the process proceeds from Step S102 to Step S103, the integration unit 300 associates the observation value of the observation ID determined to be inside the gating region 70 in Step S102 with a corresponding associated ID included in the integrated tracking ID. Note that, in FIG. 6, the association is indicated as “data association (DA)”.

In next Step S104, the integration unit 300 updates a tracking state using the observation value associated in Step S103. Then, the integration unit 300 updates the observation ID associated with the observation value in Step S103 using the observation value. Here, when the plurality of observation IDs corresponding to the tracking target 60 is detected based on the outputs of the plurality of sensors 100a, 100b, and so on, the integration unit 300 updates the state by combining all of the plurality of observation IDs detected to update the integrated tracking ID.

Upon completion of the process in Step S104, the tracking system 1 returns the process to Step S100.

Note that, according to the determination in Step S101 described above, when the same observation ID as the observation ID acquired in Step S100 is included in the observation ID associated with the integrated tracking ID (Step S101, “Yes”), there is a high possibility that the object associated with this observation ID acquired coincides with the object associated with the same observation ID acquired in the previous tracking process. However, since there is also a possibility of misrecognition in the previous tracking process, determination based on the gating region 70 is performed in Step S102 to determine whether the value is an outlier value. When the object associated with the observation ID is inside the gating region 70, the observation ID is considered to be reliable, and thus the tracking state is updated using a Kalman filter or the like (Step S104).

Returning to the description of Step S102 described above, in Step S102, when the integration unit 300 determines that the observation ID acquired is not inside the gating region 70, i.e., the observation ID acquired is outside the gating region 70 (Step S102, “out of region”), the process proceeds to Step S105.

In Step S105, the integration unit 300 determines whether or not association with the observation ID corresponding to the tracking target 60 is possible according to each characteristic of the observation value corresponding to the observation ID determined to be the same as the observation ID associated with the integrated tracking ID in Step S101 described above.

In other words, an object outside the gating region 70 is originally the outlier value, but even the object outside the gating region 70 may be detectable with high accuracy depending on the characteristic of the observation value (sensor).

For example, the observation value based on the image information acquired using the camera as the sensor and the observation value based on the point group information acquired using the radar or LiDAR as the sensor have different characteristics of the observation values. For example, to acquire the speed of the object, it is difficult to acquire the observation value with high accuracy when the camera is used as the sensor. On the other hand, when the radar is used as the sensor, it is possible to acquire the observation value with higher accuracy.

Furthermore, for example, a sensor having low reliability with respect to the speed and the position in the horizontal direction (x, z) but high reliability with respect to the position in the vertical direction (y) is considered. In the case of such a sensor, when the observation ID of the detected observation value matches the observation ID associated with the integrated tracking ID, the observation ID can be associated with the integrated tracking ID even when the corresponding object is outside the gating region 70.

Therefore, for example, regarding an object detected outside the gating region 70, although it is appropriate to process the object as the outlier value with low detection accuracy (low reliability) in the observation value by one observation method, the object may be regarded as an object corresponding to the tracking target 60 with high detection accuracy (high reliability) in the observation value by the other observation method.

In consideration of such a case, in Step S105, determination of association according to the characteristics of the observation value is performed on the observation value detected outside the gating region 70.

Note that, as a method of calculating the accuracy (reliability) of the observation value, several methods are known, but as an example, the reliability can be calculated using variance. For example, a difference between the observation value of a reference source and the observation value of a reliability calculation target is obtained, and a variance of differences is calculated. The smaller the variance is, the higher the reliability applied.

In Step S105, the integration unit 300 obtains the reliability of the observation value corresponding to the observation ID determined to be the same as the observation value corresponding to the observation ID associated with the integrated tracking ID in Step S101 described above. When the reliability obtained is equal to or greater than a threshold, the integration unit 300 determines that the observation value is the observation value corresponding to the observation ID associated with the integrated tracking ID (Step S105, “corresponding observation value is present”), and the process proceeds to Step S103.

When the process proceeds from Step S105 to Step S103, the integration unit 300 associates the observation value of the observation ID determined in Step S105 with the corresponding observation ID of the integrated tracking ID.

Note that, when the reliability of the observation ID acquired is high and the observation value is determined to be the observation value corresponding to the observation ID associated with the integrated tracking ID in Step S105, the integration unit 300 does not use the observation value acquired by a sensor other than the sensor from which the observation value corresponding to the observation ID has been acquired, and thus does not perform calculation on the observation value. As a result, a process load in the tracking system 1 is reduced.

On the other hand, when the reliability obtained is less than the threshold in Step S105, the integration unit 300 determines that the observation value is not the observation value corresponding to the observation ID associated with the integrated tracking ID (Step S105, “No corresponding observation value”), and the process proceeds to Step S110.

In Step S110, the integration unit 300 determines association (DA) with the tracking target 60 based on an observation value other than the observation ID associated with the integrated tracking ID. The process in Step S110 is similar to the determination process in Step S102 described above.

In other words, in Step S110, the integration unit 300 determines whether the observation value of the observation ID that is not associated with the integrated tracking ID in the observation IDs acquired in Step S100 is inside or outside the gating region 70. When it is determined that the observation value is inside the gating region 70, the integration unit 300 determines that the observation ID is the observation ID corresponding to the tracking target 60 in the same manner as the process in Step S102, and the process proceeds to Step S103. The process in Step S103 in this case is similar to the process at the time of proceeding from Step S102 to Step S103 described above.

On the other hand, when it is determined in Step S110 that the observation value of a target observation ID is outside the gating region 70, the integration unit 300 can execute a process similar to that in Step S105. In other words, the integration unit 300 determines whether or not to associate the observation value with the observation ID corresponding to the tracking target 60 based on the reliability of the observation value according to each characteristic of the observation value corresponding to each observation ID that is not associated with the integrated tracking ID. When the integration unit 300 determines to perform association, the process proceeds to Step S103. The process in Step S103 in this case is similar to the process at the time of proceeding from Step S105 to Step S103 described above.

Returning to the description of Step S101 described above, when the integration unit 303 determines in Step S101 that there is no observation ID same as the observation ID associated with the integrated tracking ID in observations IDs acquired in Step S100 (Step S101, “No”), the process proceeds to Step S111.

In Step S111, the integration unit 300 determines whether or not association with the tracking target 60 is possible for each observation ID acquired in Step S100, i.e., the observation value of each sensor. Similar to Step S110, the process in Step S111 is similar to the determination process in Step S102 described above.

In other words, in Step S111, in a case where the observation value acquired in Step S100 is inside the gating region 70, the integration unit 300 determines that the observation ID of the observation value is the observation ID corresponding to the tracking target 60, similarly to the process in Step S102, and causes the process to proceed to Step S103. The process in Step S103 in this case is similar to the process at the time of proceeding from Step S102 to Step S103 described above.

On the other hand, in Step S111, when the observation value acquired in Step S100 is outside the gating region 70, the integration unit 300 can execute the process similar to that in Step S105. In other words, the integration unit 300 determines whether or not to associate the observation value with the observation ID corresponding to the tracking target 60 based on the reliability of the observation value according to each characteristic of the observation value. When the integration unit 300 determines to perform association, the process proceeds to Step S103. The process in Step S103 in this case is similar to the process at the time of proceeding from Step S105 to Step S103 described above.

Note that, in FIG. 6, a process S200 including Steps S102 and S105 is an association determination process with respect to a specific observation value, and it is considered that a processing amount in Step S102 is smaller than a processing amount in Step S105. On the other hand, a process S201 including Steps S110 and S111 is an association determination process based on a large number of observation values, and has a larger processing amount than the process S200. Furthermore, it is conceivable that a processing amount in Step S110 is smaller than a processing amount in Step S111.

As described above, in the tracking process according to the embodiment, the processing amount increases in the order of Step S102, Step S105, Step S110, and Step S111, and the process priority is Step S102 > Step S105 > Step S110 > Step S111.

### 21. Specific Example of Processing According To Embodiment

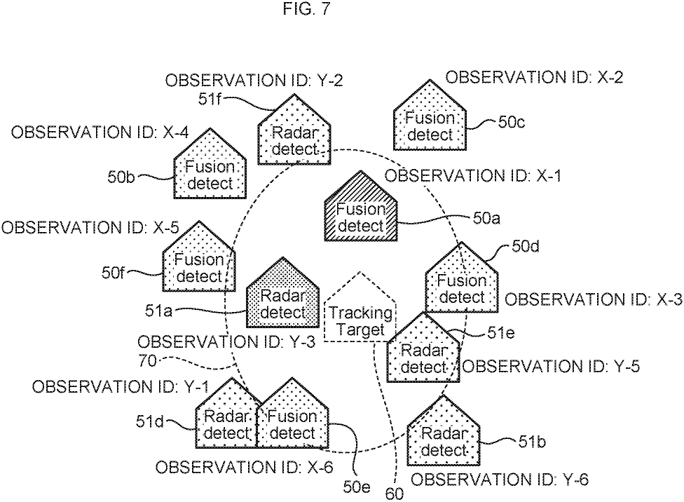

Next, processing according to the embodiment will be described using a more specific example. FIG. 7 is a schematic diagram specifically illustrating the tracking process according to the embodiment. The description will be made with reference to FIG. 7 and the flowchart of FIG. 6 described above. Note that FIG. 7 corresponds to section (b) of FIG. 2 described above, and illustrates section (b) of FIG. 2 in more detail.

In addition, in the example in FIG. 7, similarly to the case of FIG. 2 described above, the radar and the fusion sensor that is a combination of a plurality of arbitrary sensors are used as sensors. The fusion sensor and its tracking process are set as the unit X, and the radar and its tracking process are set as the unit Y.

In FIG. 7, objects 50a to 50f are detected by the fusion sensor (unit X), and observation IDs “X-1” to″X-6” are associated with the objects, respectively. Furthermore, objects 51a to 51f are detected by the radar (unit Y), and observation IDs “Y-1” to″Y-6” are associated with the objects, respectively. On the other hand, the tracking target 60 as a tracking target is generated based on a detection result acquired temporally prior to (before) the time Tn, and the gating region 70 is set based on the tracking target 60.

As a first example, in FIG. 7, it is assumed that the tracking target 60 holds observation IDs “X-1” and “Y-10” previously associated with the integrated tracking ID (hereinafter, association of a plurality of observation IDs is described as an observation ID “X-1, Y-10”).

Tracking is performed (FIG. 6, Step S100), and the observation ID is detected for each sensor (Unit X, Unit Y). As a result, the object 50a corresponding to the observation ID “X-1” is detected (FIG. 6, Step S101, “Yes”) and is inside the gating region 70 (FIG. 6, Step S102, “within region”). Therefore, the integration unit 300 determines that the observation ID “X-1” is the observation ID associated with the integrated tracking ID (FIG. 6, Step S103) .

On the other hand, the observation ID “Y-10” has not been detected in the current tracking (Step S101, “No”). Therefore, the integration unit 300 selects the observation ID to be associated with the tracking target 60 from observation IDs “Y-1” to “Y-6” detected by the unit Y (Step S111) In this example, the integration unit 300 determines that the observation ID “Y-3” corresponding to the object 51a within the gating region 70 is the observation ID to be associated with the integrated tracking ID (FIG. 6, Step S103) .

As described above, the tracking system 1 updates the tracking state using the observation IDs “X-1” and “Y-3” to update the observation ID associated with the integrated tracking ID with the observation ID “X-1, Y-3” (FIG. 6, Step S104) .

As a second example, in FIG. 7, it is assumed that the tracking target 60 holds an observation ID “X-1, Y-10” previously associated with the integrated tracking ID. As a result of the tracking, an object 50c corresponding to an observation ID “X-2” is detected, but the object 50c is outside the gating region 70 (FIG. 6, Step S102, “out of region”). In this case, when the reliability of the observation value with the observation ID “X-2” is equal to or greater than the threshold, the integration unit 300 determines that the observation ID″X-2” is the observation ID associated with the integrated tracking ID even when the object 50c corresponding to the observation ID is outside the gating region 70 (FIG. 6, Step S105, “corresponding observation value is present”, Step S103) .

For the observation ID “Y-10”, it is determined that the observation ID “Y-3” instead of the observation ID″Y-10” is the observation ID associated with the integrated tracking ID (FIG. 6, Step S103), similarly to the above-described first example.

As described above, the tracking system 1 updates the tracking state using the observation IDs “X-2” and “Y-3” to update the observation ID associated with the integrated tracking ID with the observation ID “X-2, Y-3” (FIG. 6, Step S104) .

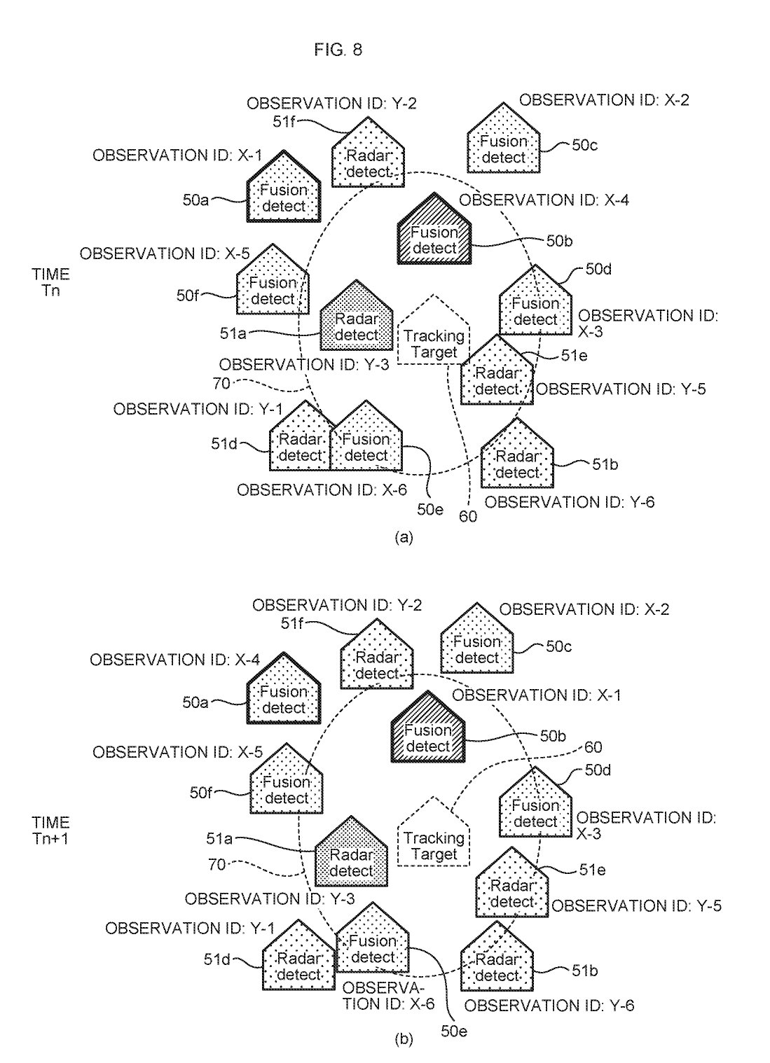

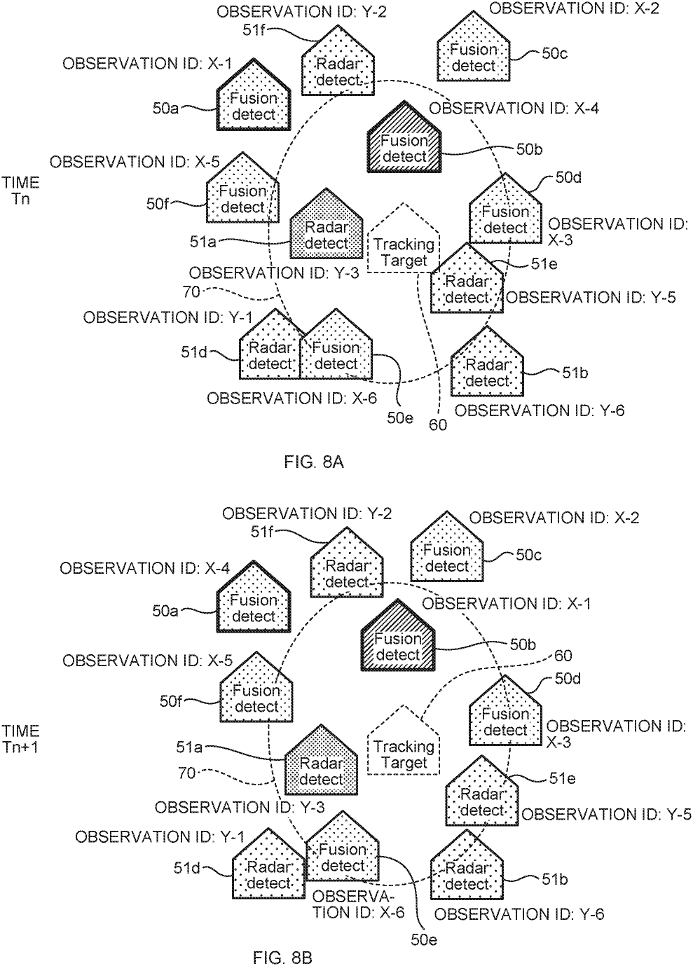

FIG. 8 is a schematic diagram illustrating still another example of the tracking process according to the embodiment. In a bird’s-eye view, section (a) of FIG. 8 illustrates an example of a detection result at the time Tn, and section (b) illustrates an example of a detection result at the time Tn + 1 after a predetermined time has elapsed from the state of section (a). Note that, in sections (a) and (b) of FIG. 8, similarly to FIG. 7 described above, the objects 50a to 50 f are detected by the unit X, and the objects 51a to 51 f are detected by the unit Y.

As illustrated in section (a) of FIG. 8, it is assumed that the tracking target 60 holds an observation ID “X-4, Y-10” associated with an integrated tracking ID at time Tn.

The object 50b in the gating region 70 is associated with the observation ID “X-4” at the time Tn, which corresponds to the integrated tracking ID at the time Tn. On the other hand, the object 50b corresponding to the observation ID “X-4” at the time Tn + 1 that is indicated in section (b) and is after a predetermined time from the time Tn is erroneously detected in the tracking at the time Tn, and is detected as an object associated with the observation ID″X-1” of the observation value newly detected at the time Tn + 1. In other words, the object 50b detected as the observation ID “X-4” at the time Tn is detected as the object corresponding to the observation value of the observation ID″X-1” at the time Tn + 1.

In other words, in Step S101 in FIG. 6, the same object 50b as the object 50b corresponding to the observation ID “X-4” associated with the tracking target 60 with respect to the observation ID is newly detected as the observation ID″X-1” at the time Tn + 1.

In this case, with respect to the observation ID “X-4”, the corresponding object 50a is detected (FIG. 6, Step S101, “Yes”) and is outside the gating region 70 (FIG. 6, Step S102, “out of region”). Here, it is assumed that the reliability of the observation value with the observation ID “X-4” is less than the threshold. In this case, the observation ID “X-4” is not selected as an observation ID to be associated with the integrated tracking ID (FIG. 6, Step S105, “No corresponding observation value”). Therefore, the integration unit 300 determines the observation ID to be associated with the integrated tracking ID based on the observation values of other observation IDs in the unit X (FIG. 6, Step S110). Here, as a result, an observation ID is selected, based on the observation value, as the observation ID to be associated with the integrated tracking ID.

For the observation ID “Y-10”, it is determined that the observation ID “Y-3” instead of the observation ID″Y-10” is the observation ID associated with the integrated tracking ID (FIG. 6, Step S103), similarly to the above-described first example.

As described above, the tracking system 1 updates the tracking state using the observation IDs “X-1” and “Y-3” to update the observation ID associated with the integrated tracking ID with the observation ID “X-1, Y-3” (FIG. 6, Step S104) .

As described above, in the embodiment, even when an erroneous tracking process is performed in a previous tracking (e.g., time Tn), the error can be corrected. In other words, even when the observation ID to be originally associated with a certain object associated with the integrated tracking ID is associated with another object, the observation ID of the certain object can be associated with the integrated tracking ID, and an error in the tracking process in the previous tracking can be corrected as long as the certain object is detected.

### 2-4. Comparison With Existing Technology

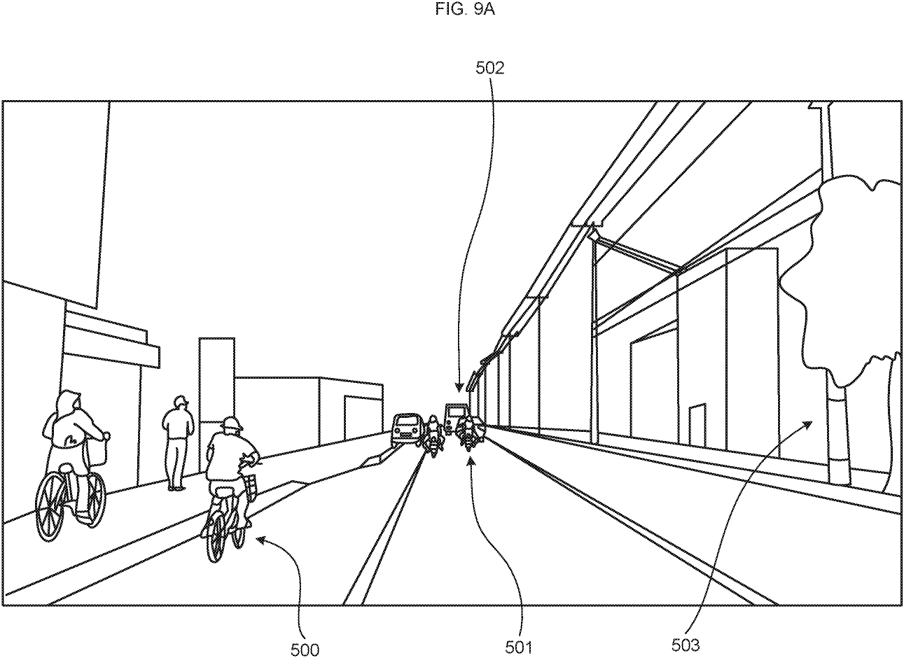

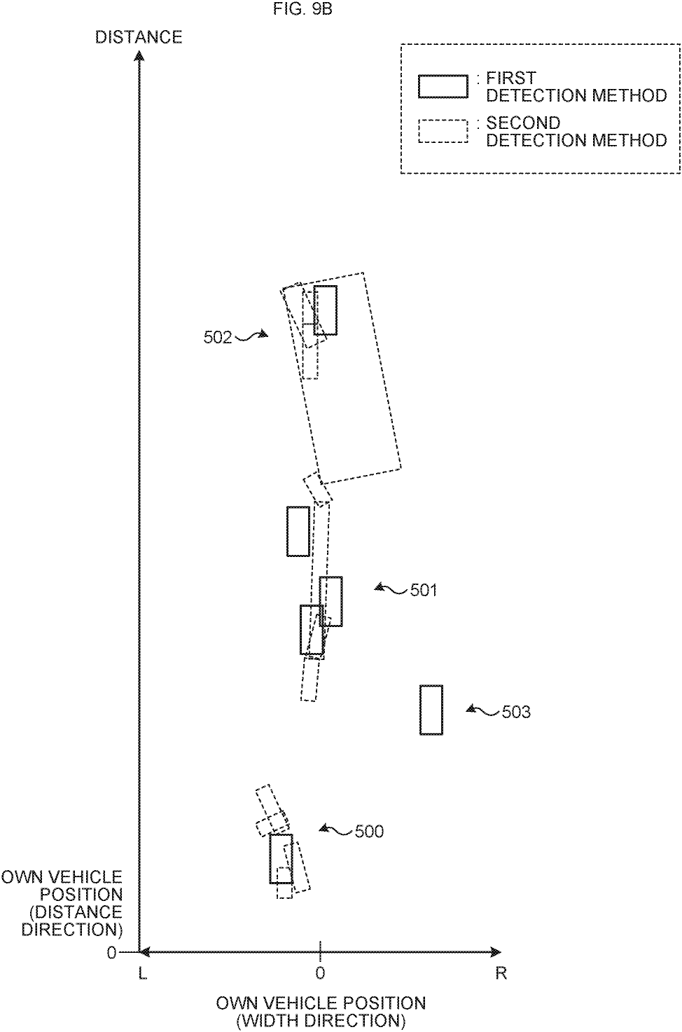

Next, a description will be given in comparison with existing technology, using actually measured data. FIG. 9A is a schematic diagram illustrating an example of an image captured by the camera. Here, it is assumed that the tracking system 1 according to the embodiment is used by being mounted on a vehicle (referred to as an own vehicle), and each of the sensors 100a to 100d is arranged in the front and directed forward to perform detection.

In the example in FIG. 9A, an object group 500 including a plurality of bicycles and pedestrians is present on the left front side of the own vehicle, an object group 501 including a plurality of motorcycles is present at a relatively long distance in front of the own vehicle, and an object group 502 including a plurality of vehicles is present further in front of the object group 501. The object groups 500, 501, and 502 move in the same direction as the own vehicle, and the moving speed of the object groups 501 and 502 is faster than the moving speed of the object group 500. In addition, on the right front side of the own vehicle, there is an object group 503 that includes a utility pole and a street tree and does not move.

FIG. 9B is a bird’s-eye view schematically illustrating an example of a detection result of each of the object groups 500 to 503 when tracking is executed in the situation illustrated in FIG. 9A. In FIG. 9B, a horizontal axis represents a position in a width direction with a center as a reference (own vehicle position), and a vertical axis represents a position in a distance direction with the own vehicle position as a reference. In FIG. 9B, a solid rectangle indicates an example of a detection result by a first detection method, and a dotted rectangle indicates an example of a detection result by a second detection method.

In this example, each of the object groups 500 to 503 is detected in a size or shape closer to an actual size or shape in the tracking result by the first detection method than in the tracking result by the second detection method. This indicates that the tracking process can be executed with higher accuracy in the first detection method than in the second detection method.

According to the existing technology, all the objects included in each of the object groups 500 to 503 are detected at every predetermined time unit. Therefore, as the number of tracking targets increases and the number of sensors increases, the observation value for detecting each object increases. As a result, it takes more time to associate the observation value with the object. This may cause a problem when a relative speed between the tracking target object and the own vehicle is high.

On the other hand, in the tracking system 1 according to the embodiment, since the identification information indicating the sensor is associated with the observation value acquired by tracking, it is possible to easily execute tracking of each sensor when a plurality of sensors is used.

Furthermore, in the tracking system 1 according to the embodiment, the observation ID is generated by associating the identification information indicating the sensor with the identification information for identifying the object (observation value) detected based on the output of the sensor, and the integrated tracking ID obtained by integrating the observation IDs of each of the sensors is associated with the tracking target. Then, tracking of the tracking target is executed based on each observation ID associated with the integrated tracking ID, and a range of the observation IDs used for tracking is widened as necessary. Therefore, the amount of calculation required for the tracking process of the tracking target can be reduced, and the time required for associating the observation value with the tracking target can be shortened.

Note that, in the above description, the tracking system 1 according to the embodiment has been described to be used in a vehicle, but this is not limited to the example. For example, when the tracking target is a vehicle and a pedestrian, it is conceivable that the tracking system 1 is arranged in a traffic light, a traffic sign, a roadside building, or the like. In addition, the tracking target to be tracked by the tracking system 1 is not limited to the vehicle or the pedestrian on a road. For example, an indoor or outdoor person can be set as the tracking target.

Note that the effects described in the present specification are merely examples and not limited, and other effects may be provided.

The present technology can also have the following configurations.

An information processing apparatus comprising:
a detection unit that detects a target based on an observation value acquired from an output of a sensor;
a generation unit that generates observation identification information in which the target detected by the detection unit based on the observation value is associated with the sensor relating to the observation value, the observation identification information being generated for each of one or a plurality of the targets detected by the detection unit; and
a control unit that controls holding, in a holding unit, of the observation identification information generated by the generation unit.

The information processing apparatus according to the above (1), wherein

the control unit holds the observation identification information in the holding unit when the target corresponding to the observation identification information is included in a predetermined region.

The information processing apparatus according to the above (2), wherein

the control unit sets the predetermined region based on the observation value corresponding to the observation identification information to be held in the holding unit.

The information processing apparatus according to the above (2) or (3), wherein
when the target corresponding to the observation identification information is not included in the predetermined region,
the control unit determines whether or not to hold the observation identification information in the holding unit based on a characteristic of the sensor corresponding to the observation identification information.

The information processing apparatus according to any one of the above (1) to (4), wherein

the control unit updates observation identification information held in the holding unit with the observation identification information generated by the generation unit and associated with the target same as the target associated with the observation identification information held in the holding unit.

The information processing apparatus according to any one of the above (1) to (5), wherein

the generation unit generates integrated identification information by integrating a plurality of pieces of the observation identification information based on outputs of a plurality of the sensors having the target in common.

The information processing apparatus according to the above (6), wherein
when the plurality of pieces of the observation identification information integrated into the integrated identification information does not include observation identification information that matches the observation identification information generated by the generation unit,
the control unit determines whether or not to hold, in the holding unit, the observation identification information corresponding to the observation value based on the observation value acquired from each of the outputs of the plurality of sensors.

The information processing apparatus according to the above (4), wherein
when the observation identification information is not held in the holding unit based on the characteristic of the sensor corresponding to the observation identification information,
the control unit determines whether or not to hold, in the holding unit, the observation identification information based on the observation value associated with observation identification information excluding observation identification information applicable to determination of whether or not to hold in the holding unit among the observation identification information associated with the target detected by the detection unit based on the observation value.

The information processing apparatus according to any one of the above (1) to (8), wherein

the detection unit detects the target based on the observation value acquired from the output of each of a plurality of the sensors.

The information processing apparatus according to any one of the above (1) to (9), wherein

the sensor includes a sensor that performs detection using light.

The information processing apparatus according to any one of the above (1) to (10), wherein

the sensor includes a sensor that performs detection using a millimeter wave.

An information processing method executed by a processor, the information processing method comprising:
a detection step of detecting a target based on an observation value acquired from an output of a sensor;
a generation step of generating observation identification information in which the target detected in the detection step based on the observation value is associated with the sensor relating to the observation value, the observation identification information being generated for each of one or a plurality of the targets detected in the detection step; and
a control step of controlling holding, in a holding unit, of the observation identification information generated in the generation step.

### REFERENCE SIGNS LIST

1 TRACKING SYSTEM
10a, 10b, 10c, 10d, 100a, 100b, 100c, 100d SENSOR
20a, 20b, 20c, 20d TRACKING PROCESS
30 INTEGRATED TRACKING PROCESS
50a, 50b, 50c, 50d, 50e, 50f, 51a, 51b, 51c, 51d, 51e, 51f OBJECT
60 TRACKING TARGET
70 GATING REGION
200a, 200b, 200c TRACKING PROCESSING UNIT
201a, 201b, 201c TRACKING ID GENERATION UNIT
300 INTEGRATION UNIT
301 OBSERVATION ID GENERATION UNIT
302 ID HOLDING UNIT
2000 INFORMATION PROCESSING APPARATUS

1. An information processing apparatus comprising:
a detection unit that detects a target based on an observation value acquired from an output of a sensor;
a generation unit that generates observation identification information in which the target detected by the detection unit based on the observation value is associated with the sensor relating to the observation value, the observation identification information being generated for each of one or a plurality of the targets detected by the detection unit; and
a control unit that controls holding, in a holding unit, of the observation identification information generated by the generation unit.

2. The information processing apparatus according to claim 1, wherein
the control unit holds the observation identification information in the holding unit when the target corresponding to the observation identification information is included in a predetermined region.

3. The information processing apparatus according to claim 2, wherein
the control unit sets the predetermined region based on the observation value corresponding to the observation identification information to be held in the holding unit.

4. The information processing apparatus according to claim 2, wherein
when the target corresponding to the observation identification information is not included in the predetermined region,
the control unit determines whether or not to hold the observation identification information in the holding unit based on a characteristic of the sensor corresponding to the observation identification information.

5. The information processing apparatus according to claim 1, wherein
the control unit updates observation identification information held in the holding unit with the observation identification information generated by the generation unit and associated with the target same as the target associated with the observation identification information held in the holding unit.

6. The information processing apparatus according to claim 1, wherein
the generation unit generates integrated identification information by integrating a plurality of pieces of the observation identification information based on outputs of a plurality of the sensors having the target in common.

7. The information processing apparatus according to claim 6, wherein
when the plurality of pieces of the observation identification information integrated into the integrated identification information does not include observation identification information that matches the observation identification information generated by the generation unit,
the control unit determines whether or not to hold, in the holding unit, the observation identification information corresponding to the observation value based on the observation value acquired from each of the outputs of the plurality of sensors.

8. The information processing apparatus according to claim 4, wherein
when the observation identification information is not held in the holding unit based on the characteristic of the sensor corresponding to the observation identification information,
the control unit determines whether or not to hold, in the holding unit, the observation identification information based on the observation value associated with observation identification information excluding observation identification information applicable to determination of whether or not to hold in the holding unit among the observation identification information associated with the target detected by the detection unit based on the observation value.

9. The information processing apparatus according to claim 1, wherein
the detection unit detects the target based on the observation value acquired from the output of each of a plurality of the sensors.

10. The information processing apparatus according to claim 1, wherein
the sensor includes a sensor that performs detection using light.

11. The information processing apparatus according to claim 1, wherein
the sensor includes a sensor that performs detection using a millimeter wave.

12. An information processing method executed by a processor, the information processing method comprising:
a detection step of detecting a target based on an observation value acquired from an output of a sensor;
a generation step of generating observation identification information in which the target detected in the detection step based on the observation value is associated with the sensor relating to the observation value, the observation identification information being generated for each of one or a plurality of the targets detected in the detection step; and
a control step of controlling holding, in a holding unit, of the observation identification information generated in the generation step.
